(19) United States
(12) Patent Application Publication
(10) Pub. No.: US 2016/0271716 A1
(43) Pub. Date: Sep. 22, 2016

(54) COOLING SYSTEM TO REDUCE LIQUID METAL EMBRITTLEMENT IN METAL TUBE AND PIPE

(71) Applicant: LUVATA FRANKLIN, INC., Franklin, KY (US)

(72) Inventor: Timothy L. Goebel, Woodburn, KY (US)

(21) Appl. No.: 15/029,532

(22) PCT Filed: Oct. 15, 2014
(86) PCT No.: PCT/US14/60787

§ 371 Date: Apr. 14, 2016

Related U.S. Application Data
(60) Provisional application No. 61/891,198, filed on Oct. 15, 2013.

(51) Int. Cl. B23K 3/08; B23K 3/04; B23K 1/008; B23K 1/00

(52) U.S. Cl. CPC B23K 3/085; B23K 1/0012; B23K 3/04; B23K 1/008; B23K 2201/14

(57) ABSTRACT

A system and method for cooling a heat exchanger.

### FIELD OF THE DISCLOSURE

The disclosure generally relates to systems and methods for the manufacture of heat exchangers.

### BACKGROUND OF THE DISCLOSURE

Brazing furnaces and manufacturing techniques for the manufacture of heat exchangers are well known. In brazing furnaces, heat exchanger tubes made from copper and aluminum, for example, can be heated to 100-200° F. hotter than the liquidus point of the braze alloy. These temperatures allow the braze alloy to melt at the junction of the joint of two tubes. Upon cooling, ideally a strong, void-free joint is formed.

Occasionally a second layer of material (e.g. a coating) is disposed on the tube for purposes such as corrosion protection. If the second layer has a lower melting point than the braze filler metal, the second layer may melt in the brazing furnace. One example of a tube with a second layer is T-Proof™ manufactured by Luvata, which includes a coating of tin. When such a second layer is heated to extreme temperatures in a brazing oven, liquid metal embrittlement (“LME”) occurs due to heat transfer from the braze joint down into the coil body. But, prior art fan systems that are located outside of a brazing furnace may not be able to cool a heat exchanger fast enough to avoid LME.

Brazing furnaces also suffer from other drawbacks, such as melted fins, over annealed joints, scored end plates, and LME. An improved cooling system for a brazing furnace is needed.

### BRIEF SUMMARY OF THE DISCLOSURE

The present disclosure can be embodied as braze furnace cooling system. The system may include a brazing heat source, and a movement mechanism configured to move a heat exchanger past the brazing heat source. The heat exchanger can include a plurality of fins and a plurality of return bends. One or more fluid nozzles can be configured to direct a sheet of pressurized fluid along the plurality of fins.

The present disclosure can also be embodied as a method of cooling a brazed heat exchanger. The method can include moving an unbrazed heat exchanger through a brazing furnace. A joint of the heat exchanger may be brazed in the brazing furnace. The brazed heat exchanger may be moved past one or more fluid nozzles. The fluid nozzles can direct a sheet of pressurized fluid along the plurality of fins. The sheet of pressurized fluid can cool the fins.

### DESCRIPTION OF THE DRAWINGS

For a fuller understanding of the nature and objects of the disclosure, reference should be made to the following detailed description taken in conjunction with the accompanying drawings, in which:

FIG. 1 depicts an exemplary heat exchanger according to the present disclosure;

FIG. 2 depicts a prior art brazing furnace and cooling system;

FIG. 3 depicts a brazing furnace and cooling system according to the present disclosure;

FIG. 4 depicts an exemplary nozzle in keeping with the present disclosure;

FIG. 5 depicts a brazing furnace with the cooling system according to the present disclosure; and

FIG. 6 is a detailed view of the cooling system of FIG. 4.

### DETAILED DESCRIPTION OF THE DISCLOSURE

In one embodiment, a cooling system according to the present disclosure is configured to cool a brazed assembly that has been brazed in a brazing furnace. Brazing is a process for joining parts, often of dissimilar compositions, to each other. Typically, a brazing filler metal (“filler material”) having a melting point lower than that of the parts to be joined together is interposed between the parts that form an assembly. The filler material can be a brazing ring, brazing plate, clad, or the like. The assembly of the parts to be brazed and the filler metal is then heated to a temperature sufficient to melt the filler material but generally lower than the melting point of the parts. Upon cooling, a strong, void-free joint is formed.

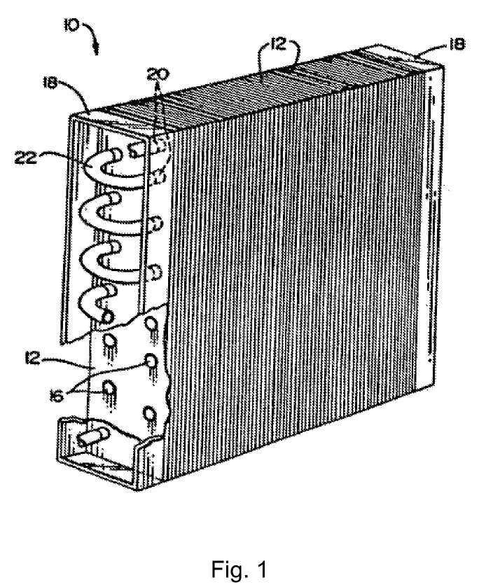

FIG. 1 depicts a plate fin and tube heat exchanger 10 containing plate fins 12 according to a known configuration. Each plate fin has a plurality of holes 16. A common method of manufacturing heat exchanger 10 is to arrange a plurality of plate fins 12 between two tube sheets 18. A plurality of tubes 20 are laced through holes 16 in the plate fins 12 and holes 16 in each of tube sheets 18. A plurality of return bends 22 are fitted to the ends of pairs of tubes 20 so as to form one or more closed fluid flow paths through the tubes 20 and return bends 22 of the heat exchanger 10. The return bends 22 may be joined to the tubes 20 by brazing. To prevent refrigerant leaks during use of the heat exchanger 10, the filler material used to join the tubes 20 to return bends 22 should reach liquidus temperature.

When installed and operating in a device such as an air conditioner, a first fluid, such as a refrigerant, flows through heat exchanger 10 via a fluid flow path or paths defined by interconnected tubes 20 and return bends 22. A second fluid, such as air, flows over and around plate fins 12 and tubes 20. If there is a temperature differential between the two fluids, heat will transfer from the warmer to the cooler of the fluids through the walls of the tubes 20 walls and via the plate fins 12.

Such heat exchangers 10 are often manufactured using a controlled atmosphere brazing furnace. In this way, for example, the components of the heat exchanger can be partially assembled before being passed through the furnace such that the tubes 20 and return bends 22 are joined by appropriate heating of the braze filler material. The system may use a conveyor, such as a conveyor belt or other conveyance mechanism. The term conveyor should be broadly interpreted herein to include belt systems, robotic arms, and other such techniques for moving materials during manufacture. The brazing furnace can include one or more sources of heat, such as brazing flames. The brazing temperatures can range between 1000° F. and 1600° F. depending on the liquidus of the filler material and the material of the tubes to be brazed. In one specific example, the brazing temperature is about 1445° F. The heat from the brazing flames can be directed at a local junction (e.g., between tube 20 and return bend 22) of two metal parts on the heat exchanger 10. Heating the local junction can cause the filler material, which has a lower melting point than that of the material(s) being joined, to flow between the material to be joined, and produce a brazed joint.

FIG. 2 depicts a typical brazing furnace 50. The brazing furnace 50 includes a furnace portion 60 and a cool down portion 70. The furnace portion 60 includes a brazing heat source 62. The brazing heat source 62 may be a brazing torch. Other appropriate heat sources will be apparent in light of the present disclosure. The heat source 62 can be fed gas from a gas source 64 via a supply line 66. The brazing heat source 62 can be a manifold with outlets 62A for producing a plurality of brazing flames. The furnace portion 60 may include a vent 67 for venting gas from the furnace 50. The vent 67 may have a fan system 68 for urging fluid flow through the vent 67. A conveyor 52 can be provided for transporting a heat exchanger 10 through the brazing furnace. The direction of travel of the conveyor system 52 is indicated with an arrow in FIG. 2. The cool down portion 70 includes fans 72 for cooling the heat exchanger 10.

In operation, the conveyor 52 carries a heat exchanger 10 through the furnace portion 60, where the heat source 62 applies heat to the joints 10A of the heat exchanger 10, for example, the joints 10A where the return bends 22 interface with the tubes 20. The application of heat causes the filler material to reach liquidus temperature and flow into the joints 10A, brazing the joints 10A. The joints 10A may be located at a top end of the heat exchanger 10. The brazed heat exchanger 10 is then carried by the conveyor 52 through the cool down portion 70. In the cool down portion 70, fans 72 are provide to cool the heat exchanger 10. Specifically, the fans 72 are positioned above heat exchanger 10 to fan air toward the newly brazed joints 10A.

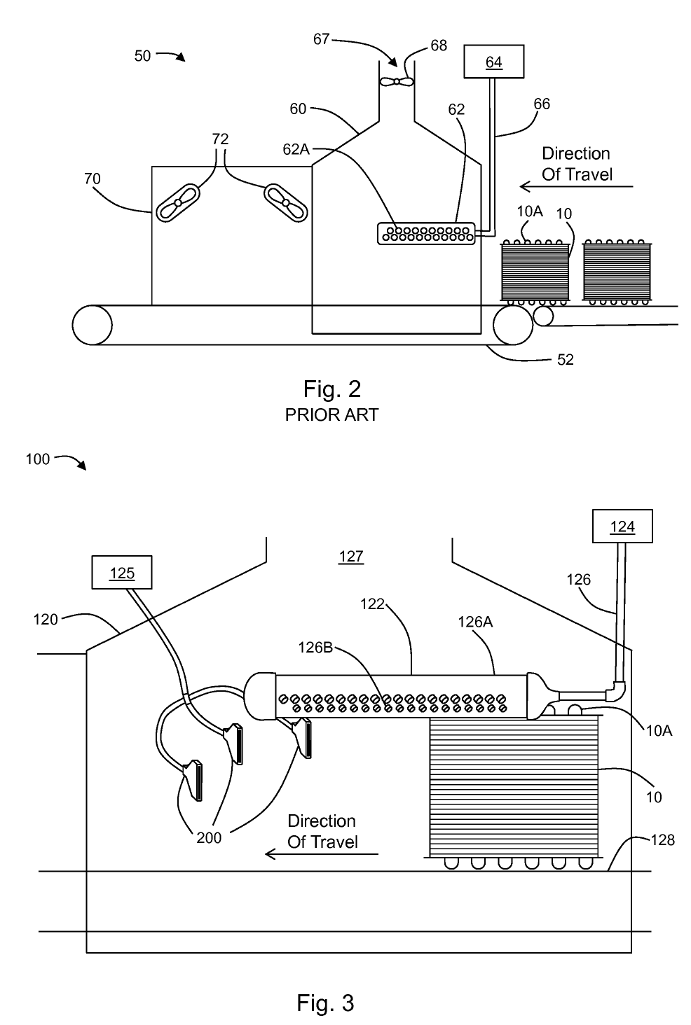

FIG. 3 shows a system 100 according to the present disclosure. The system 100 can include a furnace portion 120. The furnace portion 120 includes a brazing heat source 122. The heat source 122 can be fed gas from a gas source 124 via a supply line 126. In some embodiments, the brazing heat source 122 is a brazing torch with a manifold 126A having outlets 126B for producing a plurality of flames. The furnace portion 120 may include a vent 127 for venting gas from the furnace portion 120. The vent 127 may have a fan system for urging fluid flow through the vent 127. A conveyor 128 can be provided for transporting a heat exchanger 10 past the heat source 122. The direction of travel of the conveyor system 128 is indicated with an arrow in FIG. 3.

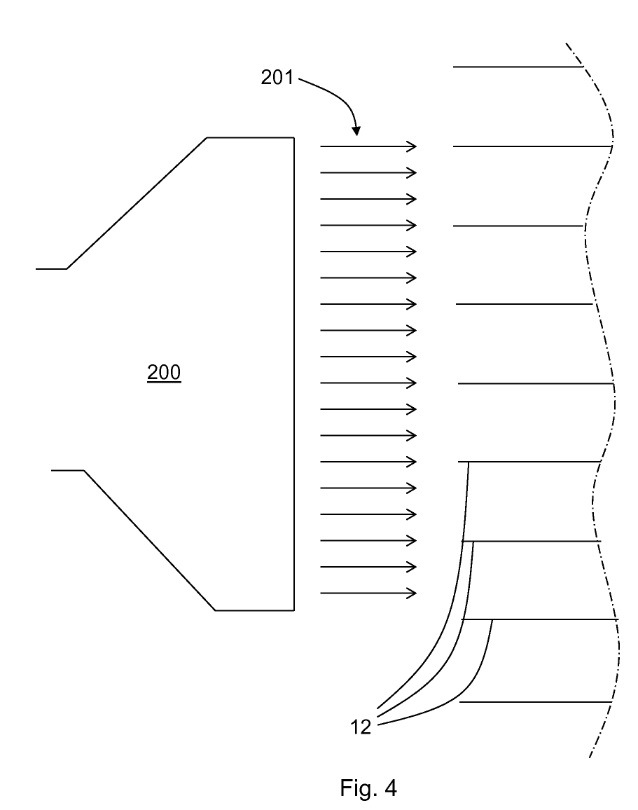

The system 100 can include one or more fluid nozzles 200. An exemplary fluid nozzle 200 is often referred to as an “air knife.” Such fluid nozzles can be configured to provide a laminar flow which can be directed with more precision than conventional fluid nozzles. The one or more fluid nozzles 200 can be positioned in the furnace portion 120 of a brazing furnace. FIG. 4 is a detail side-view of an exemplary nozzle 200. The fluid nozzles 200 can be configured to direct a sheet of fluid 201 toward the heat exchanger 110. The fluid can be air, inert gas, or any other fluid suitable for cooling in the manner disclosed. More particularly, the sheet of fluid 201 may have a height that is greater than its width. In such a configuration, the sheet can be perpendicular to the plane(s) of the plate fins) 12. In some embodiments, the sheet of fluid 201 can be configured as a narrow sheet having a laminar flow. The dimensions of the sheet of fluid 201 can generally be defined by the height and width of an outlet of the nozzle 200. In this case, because the width of the sheet of fluid 201 is relatively small, only a small portion of the length of each fin 12 receives fluid. Therefore, the entire length of each fin 12 will receive fluid as the heat exchanger 10 is carried past the nozzle 200 via the conveyor 128. Cooling fluid may be forced through a conduit to the fluid nozzle 200 with a fluid compressor 125.

The fluid nozzle 200 may be oriented such that the sheet of fluid 201 runs parallel to the fins 12 of the heat exchanger 10 as it is carried through brazing furnace portion 120. In this manner, the sheet of fluid 201 can run along the majority surface of the fins 12 of the heat exchanger 10. The flow of fluid applied from the nozzle is preferably sufficient to allow the fluid to pass through the heat exchanger 10. Therefore, the volume and/or pressure of fluid can vary depending on the width of the heat exchanger 10 (e.g., the length of the majority surface of each fin). In one example, a nozzle 200 can be fed with between 20 psi to 100 psi of air.

The fluid nozzles 200 are shown in FIG. 3 as being positioned inside the furnace portion 120. A fluid nozzle 200 can be positioned adjacent the brazing heat source 122. In this manner, the heat exchanger 10 can be cooled quickly after being brazed. It is also possible for the heat exchanger 10 to be cooled during the brazing process. For example, one or more nozzles 200 can be positioned below the heating source 122 (e.g., between the heating source 122 and the conveyor system 128). As such, the fluid 201 from the fluid nozzles 200 causes a thermal break in the tubes 20 such that the heat transfer is reduced at locations away from the joint 10A. It is also possible for the fluid nozzles 200 to be positioned outside of the brazing portion 120, or partially inside and partially outside of the brazing portion 120 of a brazing furnace system 100.

The one or more fluid nozzles 200 can be positioned at any suitable height for applying fluid along the fins 2. It may be beneficial to apply the sheet of fluid 201 to a height that is near the brazed joint 10A. In this manner, the sheet of fluid 201 may act as a thermal barrier by preventing the heat transfer from the brazed joint 10A throughout the heat exchanger 10. In one particular example, the system 100 includes a plurality of nozzles 200 that are arranged at different heights. Each nozzle can be arranged in a cascading arrangement such that the first nozzle 200 can be at a first height, closest to the brazed joint 10A; a second nozzle 200 can be at a second height, further away from the brazed joint 10A than the first nozzle; and a third nozzle 200 can be at a third height, the third height being further away from the brazed joint 10A than the second nozzle. Cooling efficiencies may be gained by such a cascading arrangement of two or more nozzles 200.

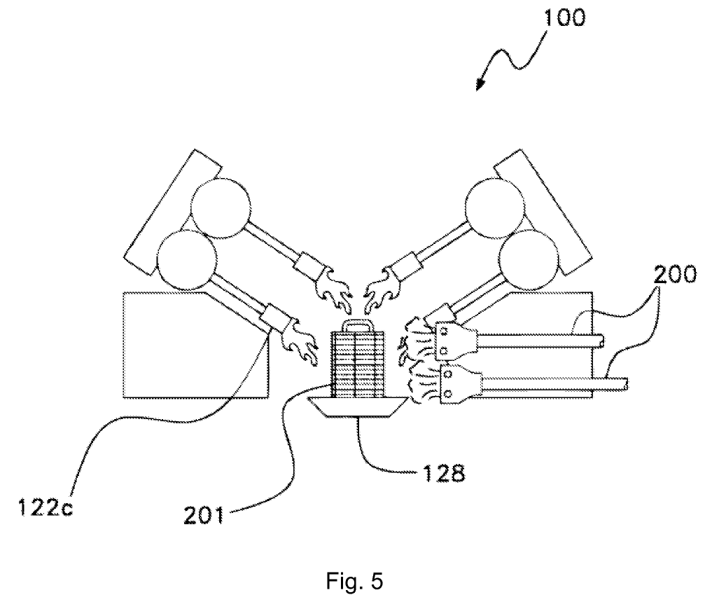

FIG. 5 shows a view of a system 100 in keeping with the present disclosure. The view is taken looking up the path of the conveyor system 128. The brazing flames 122c can be seen, along with two fluid nozzles 200. As shown, the fluid nozzles 200 can be shown positioned at different heights relative to vertical. In this manner, a sheet of fluid 201 can be initially directed at fins 12 (not shown in FIG. 5) that are closer to the brazed joint 10A (not shown in FIG. 5) by a first fluid nozzle 200. The second fluid nozzle 200 can direct a second sheet of fluid 201 at fins that are located further away from the brazed joint 10A. The sheets of fluid 201 from the first and second nozzles 200 may be positioned at overlapping heights, or be at different heights.

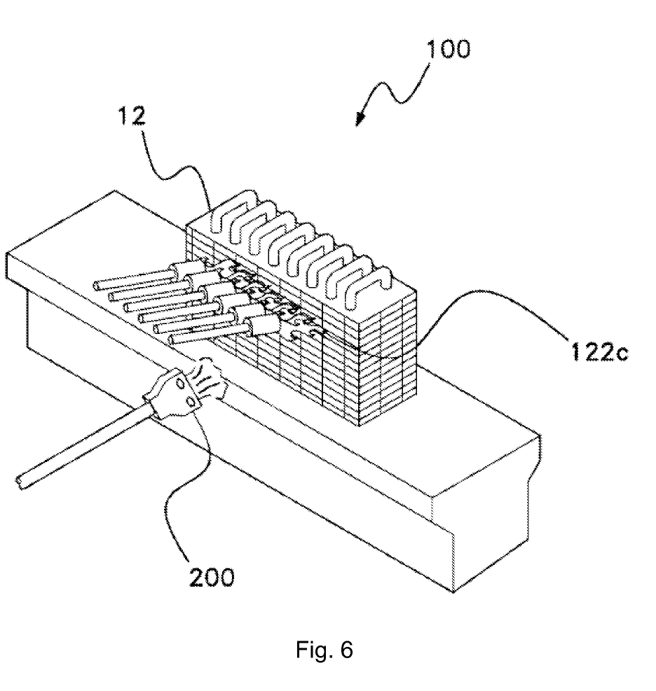

FIG. 6 shows a detailed view of a fluid nozzle 200 positioned adjacent to the brazing flames 122c. As can be seen, the fluid nozzle 200 may be positioned close to the end of the series of brazing flames 122c, along the direction of travel of the conveyor system (not shown). In this manner, the fins 12 can be cooled very quickly after the brazing process is complete.

In contrast to prior art cooling systems that cool the brazed joint 10A by fanning air at the brazed joint 10A, the present disclosure can cool the brazed joint 10A by forcing fluid through a nozzle along the fins 12 of the heat exchanger 10. In this manner, the present disclosure allows the heat exchanger 10 to cool the brazed joint 10A in a similar manner as it would operate in a device, such as an air conditioner. Specifically, the sheet of fluid is applied along the plurality of fins. By cooling the fins 12, the tubes 20 are thereby cooled. Specifically, the temperature differential between the fins 12 and tube 20 can cause heat to transfer from the warmer (tube) to the cooler (fins) by the capillary effect. Cooling the tubes 20, can thereby cool the brazed joint 10A.

The present disclosure may also be embodied as a method. The method can include moving an unbrazed heat exchanger through a brazing furnace. A joint of the heat exchanger may be brazed in the brazing furnace. The brazed heat exchanger may be moved past one or more fluid nozzles. The fluid nozzles can direct a sheet of pressurized fluid along the plurality of fins. The sheet of pressurized fluid can cool the fins.

The system and method described herein may dissipate heat more quickly than the prior art system shown in FIG. 2. Because heat from the brazing furnace quickly transfers throughout the heat exchanger 10, the heat exchanger 10 can be more quickly cooled by applying a cooling fluid flow along the fins, than by directly applying a cooling fluid flow to the brazed joint 10A. It should be noted that the present disclosure is not limited to the heat exchanger 10 shown in FIG. 1. Instead, the teachings can be applied to other apparatuses having brazed joints 10A, or other furnaces that heat apparatuses.

Pressurized fluid flow can be costly. The cooling system and method described herein can lower costs associated with cooling the brazed heat exchanger 10. For example, the cooling system and method may require less air to cool a heat exchanger than that amount of air required by existing systems and methods.

Although the present disclosure has been described with respect to one or more particular embodiments, it will be understood that other embodiments of the present disclosure may be made without departing from the spirit and scope of the present disclosure.

1. A braze furnace cooling system for brazing heat exchangers, the heat exchangers having a plurality of fins and a plurality of return bends, the system comprising:
a brazing heat source;
a conveyor configured to move heat exchangers in a direction of travel such that the return bends are proximate to the brazing heat source for a period of time;
one or more fluid nozzles configured to direct a sheet of pressurized fluid along the plurality of fins.

2. The system of claim 1, wherein the fluid nozzles are configured to provide a laminar flow of fluid.

3. The system of claim 1, wherein the one or more fluid nozzles are oriented perpendicular to the fins of the heat exchanger, such that the sheet of pressurized fluid is directed to more than two fins of the plurality of fins.

4. The system of claim 3, wherein the sheet of pressurized fluid is directed to more than five fins.

5. The system of claim 1, wherein the sheet of pressurized air is substantially parallel to the plurality of fins.

6. The system of claim 1, wherein the one or more fluid nozzles are positioned adjacent to the brazing heat source.

7. The system of claim 1, wherein the one or more fluid nozzles are positioned at a location past the brazing heat source, with respect to the direction of travel of the conveyor.

8. The system of claim 1, wherein the one or more fluid nozzles are positioned at a distance from the conveyor which is less than the distance between the brazing heat source and the conveyor.

9. The system of claim 1, wherein the one or more fluid nozzles direct a flow of fluid sufficient to pass through the heat exchanger.

10. The system of claim 1, wherein the one or more fluid nozzles are two fluid nozzles.

11. A method of cooling a heat changer, comprising:
moving an unbrazed heat exchanger through a brazing furnace;
brazing a joint of the heat exchanger in the brazing furnace;
moving the brazed heat exchanger past one or more fluid nozzles; and
directing a sheet of pressurized fluid along the plurality of fins using the one or more fluid nozzles.
